(19) United States
(12) Patent Application Publication
(10) Pub. No.: US 2007/0138691 A1
(43) Pub. Date: Jun. 21, 2007

(54) FLEXIBLE MOLD, PRODUCTION METHOD THEREOF AND PRODUCTION METHOD OF FINE STRUCTURES

(76) Inventor: Takaki Sugimoto, Kawagawa (JP)

Correspondence Address: 3M INNOVATIVE PROPERTIES COMPANY, PO BOX 33427, ST. PAUL, MN, 55133-3427, US

(21) Appl. No.: 10/595,088

(22) PCT Filed: Aug. 18, 2004
(86) PCT No.: PCT/US04/26845

§ 371 Date: Jul. 10, 2006

(30) Foreign Application Priority Data
Aug. 22, 2003 (JP) 2003-208433

(51) Int. Cl. B29C 33/40; B29C 35/08

(52) U.S. Cl. 264/219; 264/496; 249/127; 425/440; 425/DIG. 44

(57) ABSTRACT

This invention relates to a molding technology. More particularly, the invention relates to a flexible mold, its production method and a production method of a fine structure. The invention can be utilized for the production of various fine structures such as barrier ribs of a back plate of a plasma display panel.

### FIELD OF THE INVENTION

This invention relates to a molding technology. More particularly, the invention relates to a flexible mold, its production method and a production method of a fine structure. The invention can be utilized advantageously for the production of various fine structures, and can be used particularly advantageously for the production of ribs of a back plate of a plasma display panel.

### BACKGROUND OF THE INVENTION

A thin, light, flat panel display has drawn an increasing attention in recent years as a display device of a next generation as is well known. One of the typical flat panel displays is a liquid crystal display (LCD) and another is a plasma display panel (PDP). The PDP has its features in that it is thin and can provide a large display screen. Therefore, the use of the PDP for business purposes and recently, for home use as a wall-hung television, has been started.

The PDP generally contains a large number of fine discharge display cells. As schematically shown in FIG. 1, each discharge display cell 56 is defined by a pair of glass substrates, that is, a front surface glass substrate 61 and a back surface glass substrate 51, and ribs (also called “barrier ribs”, “partitions” or “barrier walls”) 54 having a fine structure and arranged into a predetermined shape between the glass substrates. The front surface glass substrate 61 is equipped thereon with a transparent display electrode 63 consisting of a scanning electrode and a retaining electrode, a transparent dielectric layer 62 and a transparent protective layer 64. The back surface glass substrate 51 is equipped thereon with an address electrode 53 and a dielectric layer 52. The display electrode 63 including the scanning electrode and the retaining electrode and the address electrode 53 intersect each other at right angles and are arranged into a predetermined pattern with a spacing, respectively. Each discharge display cell 56 has on its inner wall a phosphor layer 55, contains a rare gas (Ne—Xe gas, for example), and can cause spontaneous light emission display due to plasma discharge between the electrodes described above.

The ribs 54 are generally composed of a fine ceramic structure. Generally, the ribs 54 are arranged in advance with the address electrodes 53 on the back surface glass substrate 51 and constitute a PDP back surface plate as schematically shown in FIG. 2. Since shape accuracy and dimensional accuracy of the ribs greatly affect PDP performance, various improvements have been made in the past in molds used for producing the ribs and production methods of the ribs. For example, methods of producing cell barriers of the PDP have been proposed (Patent References 1 and 2), the methods comprising the steps of filling a radiation-curable resin into recesses of a roll intaglio printing plate having a plate surface corresponding to shapes of cell barriers of a PDP; bringing a film substrate into contact with the roll intaglio printing plate; irradiating the radiation-curable resin and curing the resin to form a cured resin layer; peeling the cured resin layer with the film substrate and producing a mold sheet having sheet recess portions having an inverted convexo-concave shape opposite to that of the cell barriers; filing a glass paste for forming a barrier into the sheet recesses of the mold sheet; bringing the mold sheet into close contact with the glass substrate; peeling the mold sheet and transferring the glass paste from the sheet recess portions to the glass substrate; and baking and curing the glass paste.

The ribs of the PDP back plate will be further explained. The rib structure is generally classified into a straight type and a grid (matrix) type, and the grid pattern rib has become dominant recently. However, a critical problem has arisen in the production of a mold that is used for producing the ribs having the grid pattern. As described above, the rib-mold is produced by the steps of filling the radiation-curable resin into the recesses of the mold such as the roll intaglio printing plate, irradiating the radiation-curable resin and curing the resin to form a cured resin layer, and peeling the cured resin layer together with the film substrate. In the case of a mold for producing a grid rib pattern having a large surface area and a complicated shape, however, large force is necessary for peeling the finished product from the mold in the peeling step. As a result, the support of the cured resin layer undergoes deformation due to peeling, and the problems such as warp of the mold, non-uniformity at the time of transfer of the ribs, deterioration of dimensional accuracy, and so forth, occur. Incidentally, because the ribs are aligned in parallel with one another in the mold for producing the straight rib pattern, no obstacle exits at all in the peeling direction from the mold, peeling is generally easy, and large peeling force that may invite deformation of the support is not necessary.

### BRIEF DESCRIPTION OF THE DRAWINGS

FIG. 1 is a sectional view showing schematically an example of prior art PDP to which this invention can be applied, too.

FIG. 2 is a perspective view showing a PDP back plate used in the PDP shown in FIG. 1.

FIG. 3 is a perspective view showing a flexible mold according to an embodiment of the invention.

FIG. 4 is a sectional view of the mold taken along a line IV-IV of FIG. 3.

FIG. 5A-5C are sectional views showing step-wise a production method of a flexible mold according to the invention.

FIG. 6A-6C are sectional views showing step-wise a production method of a PDP back plate according to the invention.

### SUMMARY

According to one aspect of the invention, there is provided a flexible mold comprising a support and a shape-imparting layer supported by the support having a groove pattern having a predetermined shape and a predetermined size on a surface thereof, wherein the support comprises a flexible film of a plastic material; the shape-imparting layer comprises a cured resin composition comprising at least one urethane acrylate oligomer and at least one (meth)acryl monomer; wherein the cured resin has a glass transition temperature of 0° C. or below.

According to another aspect of the invention, there is provided a method of producing a flexible mold comprising a support and a shape-imparting layer comprising the steps of forming a (e.g. UV) curable composition layer by applying the curable composition just described at a predetermined film thickness; stacking a flexible film support comprising a plastic material onto the master mold to thereby form a stacked body of the master mold, the curable composition layer and the support; curing for example by irradiating ultraviolet rays to the stacked body (e.g. from the side of the support); and releasing the shape-imparting layer formed upon curing of the composition layer together with the support from the master mold.

According to another aspect of the invention, there is provided a method of producing a fine structure comprising providing the flexible mold comprising the support and a shape-imparting layer with a groove pattern having a shape and a size corresponding to those of the projection pattern of the fine structure; providing a curable material between the substrate and the shape-imparting layer of the mold in order to fill the groove pattern of the mold; and curing the material thereby forming a fine structure integrally bonded with the substrate; and releasing the fine structure from the mold.

In each of the embodiments described herein, the flexible mold may comprises any one or combination of various attributes including each (meth)acryl monomer being selected from monofunctional (meth)acryl monomers and difunctional (meth)acryl monomers; the homopolymer of each urethane acrylate oligomer having a glass transition temperature ranging from −80° C. to 0° C.; the homopolymer of each (meth)acryl monomer having a glass transition temperature ranging from −80° C. to 0° C.; the polymerizable composition comprising 10 wt-% to 90 wt-% of urethane acrylate oligomer(s); the support having a glass transition temperature of 60° C. to 200° C.; the polymerizable composition cured with ultraviolet light; the support and shape-imparting layer being transparent; the viscosity of the curable composition ranging from 10 to 35,000 cps at room temperature; as well as other characteristics described herein.

### DETAILED DESCRIPTION OF THE PREFERRED EMBODIMENTS

The flexible mold, its production method and the production method of the fine structure according to the invention can be carried out advantageously in various embodiments. Hereinafter, the embodiments of the invention will be explained about the production of PDP ribs as a typical example of the fine structure, but the invention should not be of course limited to the production of the PDP ribs.

As already explained with reference to FIG. 2, the ribs 54 of the PDP are arranged on the back surface glass substrate 51 and constitute the back plate of the PDP. The gap of the ribs 54 (cell pitch) C varies with a screen size but is generally within the range of about 150 μm to about 400 μm. The ribs must generally satisfy two requirements, that is, “free from mixture of bubbles and defects such as deformation” and “high pitch accuracy”. As to pitch accuracy, each rib must be formed at a predetermined position substantially free from a positional error to the address electrode. As a matter of fact, allowance of the positional error is only within the range of dozens of μm. When the positional error exceeds this range, adverse influences are exerted on the emission condition of visible rays, etc, and satisfactory spontaneous light emission display becomes impossible. When the screen size has been increased nowadays, the problem of pitch accuracy is critical.

When the ribs 54 are considered as a whole, the error of the total pitch R (distance between ribs 54 at both ends; though only five ribs are shown in the drawing, the number of ribs is generally about 3,000) must be dozens of ppm. Generally, it is advantageous to produce the ribs by use of the flexible mold having the support and the shape-imparting layer supported by the support and having the groove pattern. In such a molding method, dimensional accuracy of about dozens of ppm or below is also required for the total pitch (distance between grooves at both ends) of the mold in the same way as the ribs.

The PDP ribs shown in the drawing can be produced easily and highly accurately by use of the flexible mold of the invention duplicated from a master mold having the shape and the size corresponding to those of the ribs. The flexible mold of the invention generally has a two-layered structure of a support and a shape-imparting layer supported by the support. However, when the shape-imparting layer itself can act as the support, the use of the support may be omitted from the mold of the invention. Though the flexible mold of the invention has basically the two-layered structure of the support and the shape imparting layer, it may comprise one or more additional layers or coatings, whenever necessary.

The form of the support, its material and its thickness in the flexible mold of the invention are not limited so long as the support has sufficient flexibility and suitable hardness capable of supporting the shape-imparting layer and securing flexibility of the mold. Generally, a flexible film (plastic film) of a plastic material having a glass transition temperature (Tg) of about 60 to about 200° C. can be advantageously used as the support. The glass transition temperature of about 60 to about 200° C. is suitable for imparting suitable hardness to the plastic film. The plastic film is preferably transparent and must have transparency sufficient at least to transmit the ultraviolet rays irradiated to form the shape-imparting layer. When the production of the PDP ribs and other fine structures from the photo-curable molding material by use of the resulting mold is taken into consideration, in particular, both support and shape-imparting layer are preferably transparent.

To control pitch accuracy of the groove portion of the flexible mold in the plastic film used as the support to dozens of ppm, a plastic material by far harder than the molding material (preferably, a photo-curable material such as a UV-curable composition) that constitutes the shape-imparting layer participating in the formation of the grooves is preferably selected for the plastic film. When a soft plastic film is used for the support, curing shrinkage of the photo-curable shape-imparting layer invites the change of the size of the support itself and pitch accuracy of the groove portions cannot be controlled to dozens of ppm because the curing shrinkage ratio of the photo-curable materials is generally several percents. When the plastic film is hard, on the other hand, dimensional accuracy of the support itself can be retained even when the photo-curable material undergoes curing shrinkage. Therefore, pitch accuracy of the groove portion can be kept with a high level of accuracy. When the plastic film is hard, pitch fluctuation can be limited to a low level when the ribs are formed. Therefore, the hard plastic film is advantageous for both moldability and dimensional accuracy. Further, when the plastic film is hard, pitch accuracy of the groove portion of the mold depends solely on the dimensional change of the plastic film. Therefore, to stably provide a mold having desired pitch accuracy, it is only necessary to conduct post-treatment so that the size of the plastic film remains as scheduled but does not change at all in the mold after production.

The hardness of the plastic film can be expressed by rigidity against tension, for example, or by tensile strength. The tensile strength of the plastic film is generally at least about 5 kg/mm² and preferably at least about 10 kg/mm². When the tensile strength of the plastic film is lower than 5 kg/mm², handling property drops when the resulting mold is released from the mold or when the PDP ribs are released from the mold, so that breakage and tear are likely to occur.

Suitable examples of plastic materials for forming the plastic film in the invention include, though not restrictive, polyethylene terephthalate (PET), polyethylene naphthalate (PEN), engineering plastic, super-engineering plastic, polycarbonate and triacetate. Among them, the PET film is particularly useful as the support, and a polyester film such as Tetoron™ film can be advantageously used as the support. These plastic films can be used as a single layered film or as a laminate film by combining two or more kinds of the plastic materials.

The plastic films described above or other supports can be used at a variety of thickness depending on the constructions of the molds and the PDP. However, the thickness is generally within the range of about 50 to 500 μm and preferably within the range of about 100 to about 400 μm. When the thickness of the support is smaller than 50 μm, rigidity of the film drops excessively and crease and breakage are likely to occur. When the thickness of the support exceeds 500 μm, on the contrary, flexibility of the film drops, so that handling property drops, too.

Generally, the plastic material is molded into a sheet to give the plastic film. The plastic film is commercially available in the form cut into the sheet or in the form taken up into a roll. If necessary, arbitrary surface treatment may be applied to the plastic film so as to improve adhesion strength of the shape-imparting layer to the plastic film.

The flexible mold according to the invention has its feature particularly in the structure of the shape-imparting layer disposed on the support described above. In other words, the shape-imparting layer has the following features.

(1) The shape-imparting layer is formed of a cured resin of a UV-curable composition containing an acryl monomer and (or) oligomer as its main component; and

(2) The cured resin constituting the shape-imparting layer has a glass transition temperature of 0° C. or below.

First, the shape-imparting layer is formed of the cured resin that is in turn formed by curing the UV-curable composition containing the acryl monomer and/or oligomer by the irradiation of ultraviolet rays. The method of forming the shape-imparting layer from the UV-curable composition is useful because an elongated heating furnace is not required for forming the shape-imparting layer and moreover, the cured resin can be acquired within a relatively short time by curing the composition. The acryl monomer(s) and urethane acrylate oligomer(s) preferably have a glass transition temperature (Tg) of about −80to about 0° C., respectively, meaning that the homopolymers thereof have such glass transition temperatures.

Examples of acryl monomers having a glass transition temperature of about −80 to about 0° C. and suitable for forming the shape-imparting layer include polyether acrylate, polyester acrylate, acrylamide, acrylonitrile, acrylic acid, acrylic acid ester, etc. However, they are not restrictive. The acryl oligomer having a glass transition temperature of about −80 to about 0° C. and suitable for forming the shape-imparting layer include urethane acrylate oligomer, polyether acrylate oligomer, polyester acrylate oligomer, epoxy acrylate oligomer, etc and are not restrictive examples. The urethane acrylate oligomer can provide a soft and strong cured resin layer after curing and has an extremely high curing rate among acrylates as a whole and can contribute to the improvement of productivity of the mold. When these acryl monomer and oligomer are used, the shape-imparting layer becomes optically transparent. Therefore, the flexible mold having such a shape-imparting layer makes it possible to use a photo-curable molding material when the PDP ribs and other fine structures are produced.

The acryl monomer and oligomer described above may be used either individually or in an arbitrary combination of two or more kinds depending on the construction of the desired mold and other factors. The inventor of this application has found that a satisfactory result can be obtained particularly when the acryl monomer and/or oligomer are a mixture of a urethane acrylate oligomer having a glass transition temperature of about −80 to about 0° C. and a mono-functional and/or bi-functional acryl monomers having a glass transition temperature of about −80 to about 0° C. A mixing ratio of the urethane acrylate oligomer and the acryl monomer in such a mixture can be changed in a broad range but it is generally preferred to use about 10 to about 90 wt %, more preferably about 20 to about 80 wt %, of the urethane acrylate oligomer on the basis of the total amount of the oligomer and the monomer. Therefore, it is preferred to use about 10 to about 90 wt %, more preferably about 20 to about 80 wt %, of the mono-functional and/or bi-functional acryl monomers. Because the urethane acrylate oligomer and the acryl monomer can be mixed in this way at ratios within the broad range while the glass transition temperature of the cured resin of the shape-imparting layer is kept at about 0° C. or below in the resulting mold, viscosity of the UV-curable composition for forming the shape-imparting layer can be set to a value suitable for the molding operation in a board range. Consequently, improvements can be achieved in that the operation is easy during the production of the mold, the film thickness can be kept constant, and so forth.

The UV-curable composition typically contains a photo-polymerization initiator and other additives, whenever necessary. Examples of the photo-polymerization initiator include 2-hydroxy-2-methyl-1-phenylpropane-1-on. The photo-polymerization initiator can be used in various amounts in the UV-curable composition, but its amount is preferably about 0.1 to about 10 wt % on the basis of the total amount of the acryl monomer and/or oligomer. When the amount of the photo-polymerization initiator is smaller than 0.1 wt %, the curing reaction is retarded or curing cannot be made sufficiently. When the amount of the photo-polymerization initiator is greater than 10 wt %, on the contrary, the non-reacted photo-polymerization initiator remains even after completion of the curing step, and problems such as yellowing and deterioration of the resin and shrinkage of the resin due to evaporation occur. An example of other useful additives is an antistatic agent.

To form the shape-imparting layer, the UV-curable composition can be used at various viscosities (measured by use of a Brookfield viscometer; so-called “B viscosity”). However, the viscosity is preferably within the range of about 10 to about 35,000 cps at room temperature (about 22° C.) and further preferably within the range of about 50 to about 10,000 cps. When the viscosity of the UV-curable composition is out of the range described above, the film formation becomes difficult in the formation of the shape-imparting layer and curing does not progress sufficiently occur.

It is also important in the flexible mold according to the invention that the curing resin originating from the UV-curable composition constituting the shape-imparting layer has a glass transition temperature (Tg) of about 0° C. or below. The glass transition temperature (Tg) often appearing in this specification is measured in a customary manner. For example, Tg of the curing resin is measured by the test method of dynamic mechanical properties by tensile vibration of a frequency 1 Hz stipulated in JIS K7244-1 (equivalent to ISO 6721-1: 1994, Plastics-Determination of Dynamic Mechanical Properties, Part 1: General Principals). The Tg represents the temperature at which a loss coefficient (loss elastic modulus/storage elastic modulus) becomes maximal when the curing resin is allowed to undergo deformation at a constant rate. That is to say, stored force is not efficiently used for the deformation of the cured resin but is lost. (In other words, the stored force is converted to thermal energy of the resin). Therefore, when the cured resin having Tg sufficiently lower than the room temperature is used as the material of the mold (shape-imparting layer), the loss of force applied to peel the mold from the master mold is kept minimal and mold release becomes easy. As a matter of fact, when Tg of the cured resin is kept at 0° C. or below, the operation of peeling the mold from the master mold for producing ribs having a large surface area and a complicated shape such as grid-like ribs becomes extremely easy. Consequently, the formation of the mold corresponding to the complicated rib shape becomes easy without causing deformation of the film-like support at the time of peel from the master mold.

Though Tg of the cured resin constituting the shape-imparting layer includes an arbitrary temperature below about 0° C., Tg is preferably within the range of about −80 to about 0° C. and further preferably within the range of about −50 to about 0° C. When Tg of the cured resin is higher than 0° C., warp occurs in the mold due to strain that occurs with the support supporting the shape-imparting layer. Also, the mold undergoes deformation when it is peeled from the mold. Therefore, deterioration of dimensional accuracy and other problems occur in the mold. When Tg of the mold is lower than −80° C., on the other hand, the elastic modulus of the resin or its cohesive force is likely to drop. Therefore, the problem of deformation or breakage of the mold occurs during formation of the ribs, or the problem that the shape-imparting layer portion (cured resin portion) at the end portion of the mold breaks occurs.

The shape-imparting layer can be used at a variety of thickness depending on the constructions of the mold and the PDP. However, the thickness is generally within the range of about 5 to about 1,000 μm, preferably within the range of about 10 to about 800 μm and further preferably within the range of about 50 to about 700 μm. When the thickness of the shape-imparting layer is below 5 μm, the necessary rib height cannot be obtained. In the shape-imparting layer according to the invention, no problem occurs in removing the mold from the master mold even when the thickness of the shape-imparting layer is as great as up to 1,000 μm to insure a large rib height. When the thickness of the shape-imparting layer is greater than 1,000 μm, stress becomes great due to curing shrinkage of the UV-curing composition, so that the problems such as warp of the mold and deterioration of dimensional accuracy occur. It is of importance in the mold according to the invention that the completed mold can be easily removed with small force from the master mold even when the depth of the groove pattern is increased in such a fashion as to correspond to the rib height, that is, even when the thickness of the shape-imparting layer is designed to a large value.

Subsequently, the construction of the flexible mold and its production method according to the invention will be explained in further detail.

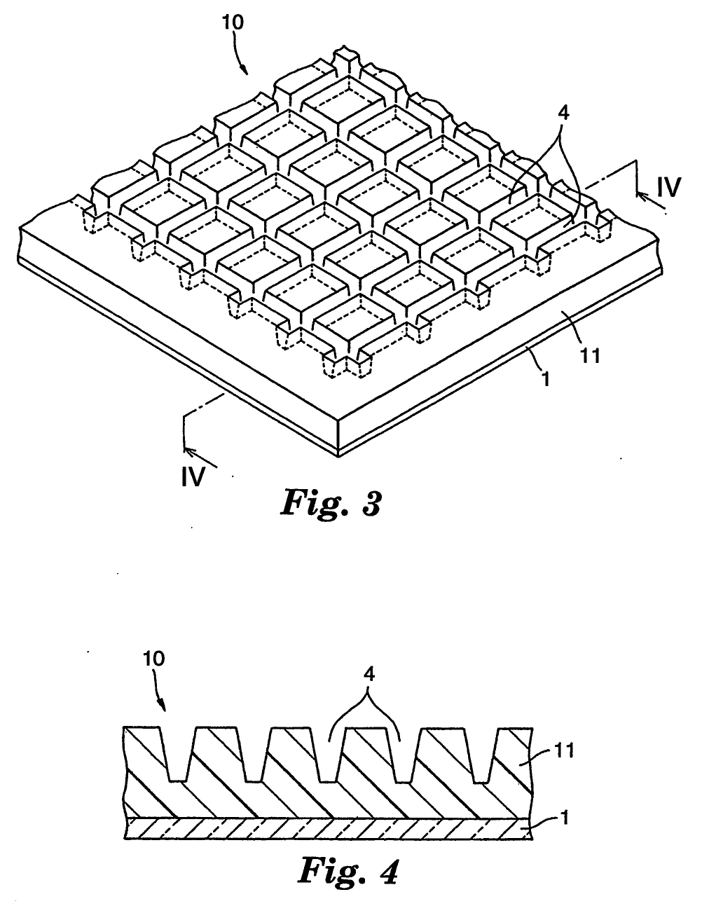

FIG. 3 is a partial perspective view typically showing a flexible mold according to a preferred embodiment of the invention, and FIG. 4 is a sectional view taken along a line IV-IV of FIG. 3. As can be understood from the drawings, the flexible mold 10 is used for producing a back surface glass substrate having a plurality of ribs so juxtaposed substantially as to intersect one another with gaps among them, that is, a grid-like rib pattern, though not shown, but not for producing the straight rib pattern back surface glass substrate 51 of FIG. 2 having a plurality of ribs 54 arranged in parallel with one another. The mold of the invention for producing the fine structure having a large and complicated shape can be easily removed from the master mold without inviting deformation and breakage as described above. Therefore, the mold can be used particularly advantageously as the shaping mold for producing the back surface glass substrate having such a grid-like rib pattern.

The flexible mold 10 has a groove pattern having a predetermined shape and a predetermined size on its surface as shown in the drawing. The groove pattern is a grid-like pattern constituted by a plurality of groove portions 4 that are arranged substantially parallel while intersecting one another with predetermined gaps among them. In other words, the flexible mold 10 can be used advantageously for forming the grid-like PDP ribs because it has the groove portions on the open grid-like pattern on the surface though the mold 10 can of course be applied to the production of other fine structures. The flexible mold 10 may have one or more additional layers, whenever necessary, or an arbitrary treatment or machining may be applied to each layer constituting the mold. Basically, however, the mold 10 comprises a support 1 and a shape-imparting layer 11 having a groove portion 4 and arranged on the support 1.

The shape-imparting layer 11 is composed of a cured resin formed by UV curing of a UV-curable composition. The UV-curable composition used for forming the shape-imparting layer 11 is as described already. Here, the groove pattern 4 formed on the surface of the shape-imparting layer 11 will be explained. The depth, pitch and width of the groove pattern 4 can be changed in a broad range depending on the pattern (straight pattern or grid pattern) of the intended PDP ribs or on the thickness of the shape-imparting layer itself. In the case of the mold of the grid-like PDP ribs shown in FIG. 3, the depth of the groove pattern 4 (corresponding to the rib height) is generally within the range of about 100 to 500 μm and preferably within the range of about 150 to about 300 μm. The pitch of the groove pattern 4 that may be different between the longitudinal direction and the transverse direction is generally within the range of about 100 to 600 μm and preferably within the range of about 200 to about 400 μm. The width of the groove pattern 4 that may be different between the upper surface and the lower surface is generally within the range of about 10 to 100 μm and preferably within the range of about 50 to about 80 μm. The shape-imparting layer 11 is preferably transparent in order to produce efficiently with high dimensional accuracy the PDP ribs by using the photo-curable material.

As already explained in detail, the support 1 for supporting the shape-imparting layer 11 is a plastic film having a glass transition temperature (Tg) of about 60 to about 200° C., and its thickness is generally within the range of about 50 to about 500 μm. Preferably, the support is optically transparent. When the support is optically transparent, the rays of light irradiated for curing can pass through the support. Therefore, the shape-imparting layer can be formed by use of the UV-curable forming composition according to the invention, and such a support is also useful for the production of the PDP ribs using a photo-curable material.

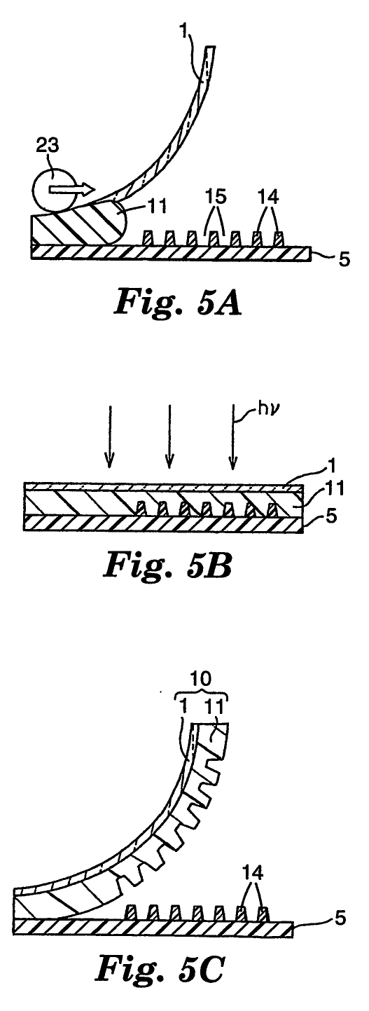

The flexible mold according to the invention can be produced in accordance with various technologies. For example, the flexible mold for producing the grid-like PDP ribs shown in FIGS. 3 and 4 can be produced advantageously in accordance with the procedures shown serially in FIG. 5.

First, as shown in FIG. 5(A), a master mold 5 having a shape and a size corresponding to those of the PDP ribs as the production object, a support composed of a transparent plastic film (hereinafter called “support film”) 1 and a laminate roll 23 are prepared. The master mold 5 has on its surface barriers 14 having the same pattern and the same shape as those of the ribs of the PDP back surface plate. Therefore, the space (recess) defined by the adjacent barriers 14 operates as the discharge display cell of the PDP. A taper may be fitted to the upper end portion of the barrier 14 to prevent entrapment of a bubble. When the same mold as that of the final rib form is prepared, the processing of the end portions after the production of the ribs becomes unnecessary, and the possible occurrence of the defect resulting from fragments created by the end portion processing can be eliminated. In this production method, the molding material for forming the shape-imparting layer is wholly cured, and thus the amount of a residue of the molding material on the master mold is small. Therefore, re-utilization of the master mold can be made easily. The laminate roll 23 is to push the support film 1 to the master mold 5 and is composed of a rubber roll. Known/customary laminate means may be used in place of the laminate roll, whenever necessary. The support film 1 is composed of the polyester film or other transparent plastic films described above.

Next, a predetermined amount of the UV-curable molding material 11 is applied to the end face of the master molds by using known/customary coating means (not shown) such as a knife coater or a bar coater. When a flexible and elastic material is hereby used for the support film 1, dimensional fluctuation exceeding 10 ppm does not occur even when the UV-curable molding material 11 undergoes shrinkage because it keeps adhesion with the support film 1 unless the support film 1 itself undergoes deformation.

Ageing is preferably carried out under the production environment of the mold before the laminate treatment in order to avoid any dimensional change of the resulting support film from moisture. Unless this ageing treatment is conducted, a dimensional error (in order of 300 ppm, for example) that cannot be allowed may occur in the resulting mold.

Next, the laminate roll 23 is rolled on the master mold 5 in a direction indicated by an arrow. As a result of this laminate treatment, the molding material 11 is uniformly distributed at a predetermined thickness, and fills the gaps of the barriers 14. Because the support film 1 distributes the molding material 11, de-foaming is more excellent than the coating methods that have generally been used in the past.

After the laminate treatment is completed, the ultraviolet rays (hv) are irradiated to the molding material 11 as indicated by arrows through the support film 1 under the state where the support film 1 is stacked on the master mold 5 as shown in FIG. 5(B). When the support film 1 is uniformly formed of the transparent material not containing light-scattering factors such as bubbles, the irradiated rays of light hardly attenuate and can uniformly reach the molding material 11. As a result, the molding material can be efficiently cured and turns to the uniform shape-imparting layer 11 bonded to the support film 1. In consequence, there can be obtained the flexible mold having the support film 1 and the shape-imparting layer 11 integrally bonded to each other. Incidentally, since the ultraviolet rays having a wavelength of 350 to 450 nm, for example, can be used in this process, there is the merit that a light source generating high heat such as a high-pressure mercury lamp like a fusion lamp need not be used. Further, because the support film and the shape-imparting layer do not undergo thermal deformation, there is another merit that pitch control can be made with a high level of accuracy.

Next, as shown in FIG. 5(C), the flexible mold 10 is separated from the master mold 5 while keeping its integrity.

The flexible mold according to the invention can be formed relatively easily irrespective of its size by employing suitable known/customary laminate means and coating means. Therefore, the invention can easily produce a large-scale flexible mold without any limitations unlike the production methods of the prior art using vacuum installation such as a vacuum press-molding machine.

In addition, the flexible mold according to the invention is useful for molding the PDP ribs having the straight rib pattern or the grid-like rib pattern. When this flexible mold is used, a PDP for a large screen, can be conveniently produced by merely using the laminate roll in place of the vacuum installation and/or the complicated process.

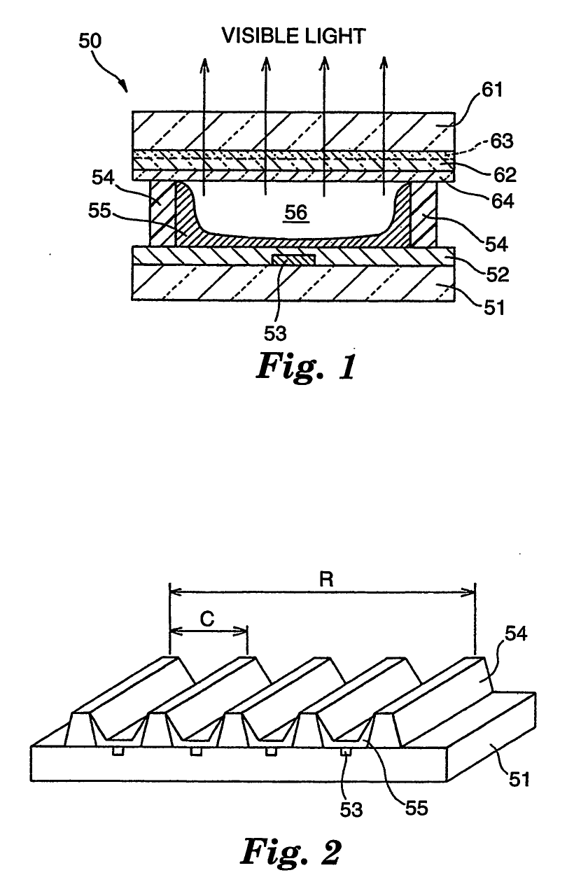

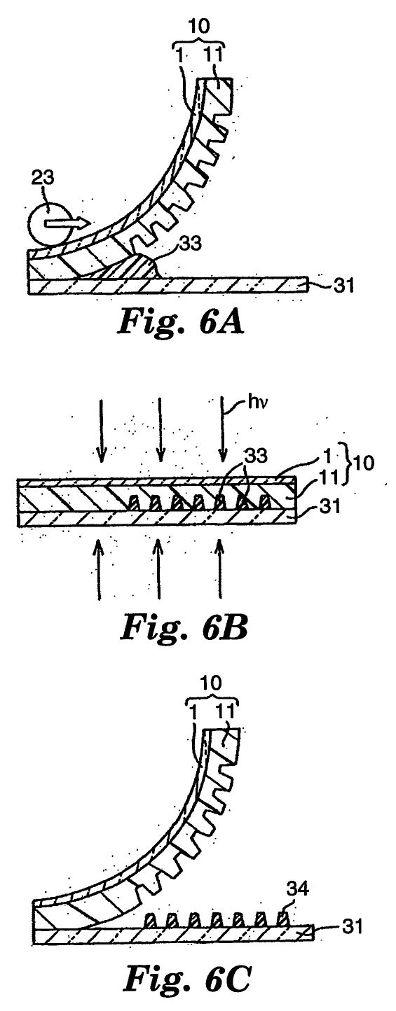

Another feature of the invention resides in a production method of a fine structure by using the flexible mold according to the invention. The fine structure can have various structures, and a typical example thereof is a PDP substrate (back plate) having ribs formed on a flat glass sheet. Next, a method of producing the PDP ribs having the grid-like rib pattern using the flexible mold 10 produced by the method shown in FIG. 5 will be explained step-wise with reference to FIG. 6. Incidentally, a production apparatus shown in FIGS. 1 to 3 of Japanese Unexamined Patent Publication (Kokai) No. 2001-191345 can be advantageously used to carry out the method of the invention.

The flexible mold 10, produced by the method shown in FIG. 5, can be used to produce PDP ribs (e.g. having a grid-like pattern). With reference to FIG. 6, a glass flat sheet, not shown, on which stripe-like electrodes are arranged in a predetermined pattern, is prepared and is then set to a stool. Next, as shown in FIG. 6(A), the flexible mold 10 of the invention having the groove pattern on its surface is put at a predetermined position of the glass flat sheet 31, and the glass flat sheet 31 and the mold 10 are positioned (aligned). Since the mold 10 is transparent, its positioning with the electrodes on the glass flat sheet 31 is easy. Hereinafter, detailed explanation will be given. This positioning may be conducted with eye or by use of a sensor such as a CCD camera, for example. In this instance, the groove portions of the mold 10 and the gaps between the adjacent electrodes on the glass flat sheet 31 may be brought into conformity by adjusting the temperature and the humidity, whenever necessary. Generally, the mold 10 and the glass flat sheet 31 undergo extension and contraction in accordance with the change of the temperature and the humidity, and the extents are mutually different. Therefore, after positioning of the glass flat sheet 31 and the mold 10 is completed, control is so made as to keep the temperature and the humidity at that time constant. Such a controlling method is particularly effective for producing a PDP substrate having a large area Subsequently, the laminate roll 23 is put at one of the ends of the mold 10. The laminate roll 23 is preferably a rubber roll. In this way, one of the ends of the mold 10 is preferably fixed onto the glass flat sheet 31, and one can prevent the positioning error of the glass flat sheet 31 and the mold 10 for which positioning has previously been completed.

Next, the other free end of the mold 10 is lifted up by use of a holder (not shown) and is moved above the laminate roll 23 to expose the glass flat sheet 31. Tension must not be applied at this time to the mold 10 so as to prevent crease in the mold 10 and to keep positioning between the mold 10 and the glass flat sheet 31. However, other means may be used so long as this positioning can be kept. Because the mold 10 has flexibility in this production method, even when the mold 10 is turned up as shown in the drawing, the mold 10 can correctly return to the original positioning state.

Subsequently, a predetermined amount of a rib precursor 33 necessary for forming the ribs is supplied onto the glass flat sheet 31. A paste hopper having a nozzle, for example, can be used for supplying the rib precursor.

Here, the term “rib precursor” means an arbitrary molding material that can finally form the intended rib molding, and is not particularly limited. The precursor may be either heat-curable or photo-curable. The photo-curable rib precursor can be used extremely effectively when combined with the transparent flexible mold. As described above, the flexible mold can suppress non-uniform scatter of light without involving defects such as bubbles and deformation. The molding material can thus be cured uniformly and provides the ribs having stable and excellent quality.

An example of the composition suitable for the rib precursor is a composition basically containing (1) a ceramic component that provides a rib shape such as aluminum oxide, (2) a glass component that fills the gaps among the ceramic components and imparts compactness to the ribs such as lead glass or phosphate glass, and (3) a binder component for storing and keeping the ceramic component and combining with the ceramic component, and its curing agent or its polymerization initiator. Curing of the binder component is preferably attained through irradiation of light without relying on heating. In such a case, thermal deformation of the glass flat sheet need not be taken into account. Whenever necessary, an oxidation catalyst consisting of an oxide, a salt or a complex of chromium (Cr), manganese (Mn), iron (Fe), cobalt (Co), nickel (Ni), copper (Cu), zinc (Zn), indium (In), tin (Sn), ruthenium (Ru), rhodium (Rh), palladium (Pd), silver (Ag), iridium (Ir), platinum (Pt), gold (Au) or cerium (Ce) is added to this composition to thereby lower the removing temperature of the binder component.

When the production method shown in the drawing is carried out, the rib precursor 33 is not supplied uniformly to the entire portion on the glass flat sheet 31. The rib precursor 33 needs be supplied to the glass flat sheet 31 only in the proximity of the laminate roll 23 as shown in FIG. 6(A). When the laminate roll 23 moves on the mold 10 in the subsequent step, it can uniformly spread the rib precursor 33 on the glass flat sheet 31. In such a case, however, the rib precursor 33 has generally a viscosity of about 20,000 cps or below and more preferably about 5,000 cps or below. When the viscosity of the rib precursor is higher than about 20,000 cps, the laminate roll cannot sufficiently spread the rib precursor. In consequence, air is entrapped into the groove portions of the mold and may result in the rib defect. As a matter of fact, when the viscosity of the rib precursor is about 20,000 cps or below, the rib precursor uniformly spreads between the glass flat sheet and the mold when the laminate roll is moved only once from one of the ends to the other end of the glass flat sheet, and can uniformly fill all the groove portions without entrapping air. However, the supplying method of the rib precursor is not limited to the method described above. For example, the rib precursor may well be coated to the entire surface of the glass flat sheet, though this method is not shown in the drawing. In this case, the rib precursor for coating has the same viscosity as described above. When the ribs having the grid-like pattern are formed, in particular, the viscosity is about 20,000 cps or less, preferably about 10,000 cps or less and in some embodiments about 5,000 cps or below.

Next, a motor (not shown) is driven and the laminate roll 23 is moved at a predetermined speed on the mold 10 as shown in FIG. 6(A). While the laminate roll 23 is moving in this way on the mold 10, a pressure is applied to the mold 10 from one of its ends to the other due to the weight of the laminate roll 23, and the rib precursor 33 spreads between the glass flat sheet 31 and the mold 10 and fills the groove portions of the mold 10, too. In other words, the rib precursor 33 sequentially replaces air of the groove portions and fills the groove portions. At this time, the thickness of the rib precursor can be adjusted to the range of several to dozens of μm when the viscosity of the rib precursor, the diameter of the laminate roll, its weight or its moving speed are suitably adjusted.

According to the production method shown in the drawing, the groove portions of the mold can also act as air channels. Even when the groove portions collect air, air can be efficiently discharged outside the mold and its peripheral portion when the pressure described above is applied. As a result, this production method can prevent the bubbles from remaining even when the rib precursor is charged at the atmospheric pressure. In other words, a reduced pressure need not be applied to charge the rib precursor. Needless to say, however, the bubbles can be removed more easily under the reduced pressure state.

Subsequently, the rib precursor is cured. When the rib precursor 33 spread on the glass flat sheet 31 is of the photo-curable type, the stacked body of the glass flat sheet 31 and the mold 10 is put into a light irradiation apparatus (not shown), and the rays of light such as the ultraviolet rays are irradiated to the rib precursor 33 through the glass flat sheet 31 and the mold 10 to cure the rib precursor 33. A molded product of the rib precursor, that is, the ribs per se, can be obtained in this way.

Finally, because the resulting ribs 34 remain bonded to the glass flat sheet 31, the glass flat sheet 31 and the mold 10 are taken out from the light irradiation apparatus and the mold 10 is peeled and removed as shown in FIG. 6(C). Because the mold 10 according to the invention is excellent in the handling property, too, the mold 10 can be easily peeled and removed with limited force without breaking the ribs 34 bonded to the glass flat sheet 31. Needless to say, a large-scale apparatus is not necessary for this peeling/removing operation.

### EXAMPLES

The invention will be explained concretely with reference to the following examples. Incidentally, those skilled in the art could easily understand that the invention is not limited to these examples.

Production of Flexible Mold

To produce PDP back plates having ribs of a grid-like pattern, nine kinds of flexible molds are produced in the following way. Incidentally, the molds produced in this example are molds having on their surface a grid-like groove pattern composed of a plurality of groove portions that intersect one another with predetermined gaps among them and are arranged substantially parallel to one another.

First, a rectangular master mold having a grid-like rib pattern corresponding to the grid-like rib pattern of each PDP back plate is prepared. The size of the master mold is 125 mm in length×250 mm in width. Each rib intersection of the master mold has a longitudinal rib and a transverse rib each having an isosceles trapezoidal sectional shape. These longitudinal and transverse ribs are arranged substantially parallel while intersecting one another with predetermined gaps among them. Each rib has a height of 210 μm (for both longitudinal and transverse ribs), a top width of 60 μm, a bottom width of 120 μm, a pitch of the longitudinal ribs (distance between centers of adjacent longitudinal ribs) of 300 μm and a pitch of the transverse ribs of 510 μm.

To form a shape-imparting layer of the mold, a urethane acrylate oligomer, an acryl monomer and a photo-polymerization initiator, listed below, are blended in different amounts (wt %) tabulated in Table 1 to obtain UV-curable compositions 1 to 9.
Urethane acrylate oligomer A:
   aliphatic bi-functional urethane acrylate oligomer (molecular weight: 4,000, product of Daicel-UBC Co.), Tg: 15° C.
Urethane acrylate oligomer B:
   aliphatic bi-functional urethane acrylate oligomer (molecular weight: 13,000, product of Daicel-UBC Co.), Tg: −55° C.
Acryl monomer C:
   isobornyl acrylate (molecular weight: 208), Tg: 94° C.
Acryl monomer D:
   phenoxyethyl acrylate (molecular weight: 193), Tg: 10° C.
Acryl monomer E:
   buthoxyethyl acrylate (molecular weight: 172), Tg: −50° C.
Acryl monomer F:
   ethylcarbitol acrylate (molecular weight: 188), Tg: −67° C.
Acryl monomer G:
   2-ethylhexyl-diglycol acrylate (molecular weight: 272), Tg: −65° C.
Acryl monomer H:
   2-butyl-2-ethyl-1,3-propanediol acrylate (molecular weight: 268), Tg: 108° C.
Photo-polymerization initiator:
   2-hydroxy-2-methyl-1-phenyl-propane-1-on (product of Chiba Specialty Chemicals Co., product name “Darocure 1173”)

Further, to use as a support of the mold, a PET film having a size of 400 mm in length, 300 mm in width and 188 μm in thickness (product of Teijin Co. trade name “HPE18”, Tg: about 80° C.) is prepared.

Next, each UV-curable composition is applied in a line form to the upstream end of the master mold so prepared. The PET film described above is then laminated in such a fashion as to cover the surface of the master mold. The longitudinal direction of the PET film is parallel to the longitudinal ribs of the master mold, and the thickness of the UV-curable composition sandwiched between the PET film and the master mold is set to about 250 μm. When the PET film is sufficiently pushed by use of a laminate roll, the UV-curable composition is completely filled into the recesses of the master mold, and entrapment of bubbles is not observed.

The ultraviolet rays having a wavelength of 300 to 400 nm (peak wavelength: 352 nm) are irradiated under this state from a fluorescent lamp, a product of Mitsubishi Denki-Oslam Co., to the UV-curable composition for 60 seconds through the PET film. The irradiation dose of the ultraviolet rays is 200 to 300 mJ/cm². The UV-curable composition is cured to obtain a shape-imparting layer. Subsequently, the PET film and the shape-imparting layer are peeled from the master mold to obtain a flexible mold equipped with a large number of groove portions having a shape and a size corresponding to those of the ribs of the master mold.

Test Methods

The following measurements are made for each of the UV-curable compositions 1 to 9 used in the production process of the flexible mold:
(1) elastic modulus (Pa) under the rubber state;
(2) glass transition temperature (Tg, ° C.) of cured resin; and
(3) viscosity (cps, at 22° C.) of the uncured resin.

The result is tabulated in Table 1.

(1) Elastic Modulus under Rubber State

Each UV-curable composition is cured through the irradiation of the ultraviolet rays in the same way as described above, and a rectangular cured resin film (22.7 mm in length, 10 mm in width and 200 μm in thickness) is prepared. The elastic modulus of this test-piece is measured by use of a dynamic visco-elastometer (model “RSAII”, product of Rheometrics Co.).

(2) Glass Transition Temperature of Cured Resin

Each UV-curable composition is cured through the irradiation of the ultraviolet rays in the same way as described above, and a rectangular cured resin film (22.7 mm in length, 10 mm in width and 200 μm in thickness) is prepared. The glass transition temperature (Tg) of this test-piece is measured in accordance with the test method stipulated in JIS K7244-1. The test-piece is fitted to a dynamic visco-elastometer (model “RSAII”, product of Rheometrics Co.), and dynamic mechanical properties are measured at a deformation frequency of 1 Hz, a maximum deformation amount of 0.04% and a temperature elevation rate of 5° C./min. The glass transition temperature is calculated from the measurement value so obtained.

(3) Viscosity

Brookfield viscosity is measured at room temperature (22° C.) using a B type viscometer.

Evaluation Test

In the production process of the flexible mold described above, whether or not the mold undergoes peel deformation (deformation of PET film resulting from peeling) when the mold is peeled from the master mold is evaluated. In addition, the relation between the existence/absence of peel deformation and the glass transition temperature (Tg) of each UV-curable composition is examined.

After the shape-imparting layer is formed by curing the UV-curable composition, the PET film and the shape-imparting layer integrated with the PET film are subjected to 180° peeling at a tensile speed of about 100 mm/sec in a tensile direction parallel to the longitudinal ribs of the master mold and parallel to the mold surface, and the mold is then removed from the master mold. Next, the longitudinal direction of the PET film is oriented and is brought into contact with the vertical wall surface for the mold immediately after it is peeled from the master mold. While the PET film keeps contact with the wall surface, an upper end side (a part) of the PET film is bonded and fixed to the wall surface by use of an adhesive tape. Warp of the center portion of the PET film is measured while it is unfixed, and when the warp amount is 30 mm or more, the PET film is evaluated as “having peel deformation”. When the warp amount is less than 30 mm, the PET film is evaluated as “no peel deformation”. The evaluation result so obtained is tabulated in the following Table 1.

TABLE 1

| | UV-curable composition | | | | | | | | |
|---|---|---|---|---|---|---|---|---|---|
| Component | 1 | 2 | 3 | 4 | 5 | 6 | 7 | 8 | 9 |
| urethane acrylate oligomer A | 80 | 40 | 40 | 40 | 40 | | | | |
| urethane acrylate oligomer B | | | | | | 100 | 50 | 50 | 50 |
| acryl monomer C | | 50 | | | | | | | |
| acryl monomer D | 20 | 10 | 60 | 10 | 10 | | | 25 | 50 |
| acryl monomer E | | | | 50 | | | | | |
| acryl monomer F | | | | | 50 | | | | |
| acryl monomer G | | | | | | | 50 | 25 | |
| acryl monomer H | | | | | | | 10 | 10 | 10 |
| photopolymerization initiator | 1 | 1 | 1 | 1 | 1 | 1 | 1.1 | 1.1 | 1.1 |
| Tg (° C.) | 15 | 40 | 10 | −20 | −30 | −55 | −40 | −20 | 10 |
| elastic modulus under rubber state (Pa) | 1.E+07 | 3.E+06 | 4.E+06 | 4.E+06 | 4.E+06 | 5.E+06 | 4.E+06 | 4.E+06 | 5.E+06 |
| peel deformation | yes | yes | yes | no | no | no | no | no | yes |
| viscosity (cps, 22° C.) | 10000 | | | | 50 | 45000 | 300 | | |

It can be understood from Table 1 that there are a number of possible UV curable compositons which meet the criteria set forth herein and hence can be used to form the mold for the PDP ribs without involving peel deformation.

Production of PDP Back Plate

The flexible mold produced using each of the UV-curable compositions 4, 5, 7 and 8 in the manner as described above is arranged and positioned on the PDP glass substrate. The groove pattern of the mold is so arranged as to oppose the glass substrate. Next, a photosensitive ceramic paste is charged between the mold and the glass substrate. The ceramic paste used herein has the following composition.

Photo-Curable Oligomer:

| | | |
|---|---|---|
| bisphenol A diglycidyl methacrylate acid addition product | 21.0 | g |
| (product of Kyoeisha Kagaku K.K.) | | |
| Photo-curable monomer: | | |
| triethyleneglycol dimethacrylate (product of Wako | 9.0 | g |
| Junyaku Kogyo K.K.) | | |

Diluent:

| | | |
|---|---|---|
| 1,3-butanediol (product of Wako Junyaku Kogyo K.K.) | 30.0 | g |
| Photo-polymerization initiator: | | |
| bis(2,4,6-trimethylbenzoyl)-phenylphosphine oxide (Chiba | 0.3 | g |
| Specialties, Co., trade name “Irgacure 819”) | | |

Surfactant:

| | | |
|---|---|---|
| phosphate propoxyalkylpolyol | 3.0 | g |
| Inorganic particles: | | |
| mixed powder of lead glass and ceramic (product of Asahi | 180.0 | g |
| Glass Co.) | | |

After charging of the ceramic paste is completed, the mold is laminated in such a fashion as to cover the surface of the glass substrate. When the mold is sufficiently pushed by use of a laminate roll, the ceramic paste can be completely charged into the groove portions of the mold.

Under this state, the ultraviolet rays having a wavelength of 300 to 450 nm (peak wavelength: 352 nm) are irradiated from a fluorescent lamp, a product of Phillips Co., for 30 seconds from both surfaces of the mold and the glass substrate. The irradiation dose of the ultraviolet rays is 200 to 300 mJ/cm². The ceramic paste is cured and changes to the ribs. Subsequently, the glass substrate is peeled with the ribs on the glass substrate from the mold to obtain an intended PDP back plate composed of the glass substrate with the ribs. In each of the back plates, the shape and the size of the ribs are correctly coincident with those of the ribs of the master mold used for producing the mold, and defect such as breakage of the ribs is not observed.

1. A flexible mold comprising a support and a shape-imparting layer supported by said support, wherein:
said support comprises a flexible film of a plastic material;
said shape-imparting layer comprises the reaction production of a polymerizable composition comprising at least one urethane acrylate oligomer and at least one (meth)acryl monomer; wherein said cured resin has a glass transition temperature of no greater than 0° C.

2. The flexible mold of claim 1 wherein each (meth)acryl monomer is selected from monofunctional (meth)acryl monomers and (meth)acryl difunctional monomers.

3. The flexible mold of claim 1 wherein each urethane acrylate oligomer has a homopolymer having a glass transition temperature ranging from −80° C. to 0° C.

4. The flexible mold of claim 1 wherein each (meth)acryl monomer has a homopolymer having a glass transition temperature ranging from −80° C. to 0° C.

5. The flexible mold of claim 1 wherein the polymerizable composition comprises 10 wt-% to 90 wt-% of the urethane acrylate oligomer.

6. The flexible mold of claim 1 wherein the support has a glass transition temperature of 60° C. to 200° C.

7. The flexible mold of claim 1 wherein the polymerizable composition is cured with ultraviolet light.

8. A flexible mold of claim 1, wherein said support and said shape-imparting layer are transparent.

9. A flexible mold of claim 1, wherein a viscosity of said polymerizable composition ranges from 10 cps to 35,000 cps at room temperature.

10. A flexible mold of claim 1, wherein said plastic material is at least one plastic material selected from the group consisting of polyethylene terephthalate, polyethylene naphthalate, stretched polypropylene, polycarbonate and triacetate.

11. A flexible mold of claim 1, wherein a thickness of said support ranges from 50 μm to 500 μm.

12. A method of producing a flexible mold comprising the steps of:
applying a polymerizable composition to a master mold wherein the composition comprises at least one urethane acrylate oligomer and at least one (meth)acryl monomer;
wherein said cured composition exhibits a glass transition temperature of no greater than 0° C.;
stacking a flexible film support comprising a plastic material onto said master mold;
curing said polymeriable composition; and
removing said master mold.

13. The method of claim 12 wherein each (meth)acryl monomer is selected from monofunctional (meth)acryl monomers and (meth)acryl difunctional monomers.

14. The method of claim 12 wherein each urethane acrylate oligomer has a homopolymer having a glass transition temperature ranging from −80° C. to 0° C.

15. The method of claim 12 wherein each (meth)acryl monomer has a homopolymer having a glass transition temperature ranging from −80° C. to 0° C.

16. The method of claim 12 wherein the polymerizable composition comprises 10 wt-% to 90 wt-% of the urethane acrylate oligomer.

17. The method of claim 12 wherein the support has a glass transition temperature of 60° C. to 200° C.

18. The method of claim 12 wherein the polymerizable composition is cured with ultraviolet light.

19. A method of producing a fine structure comprising the steps of:
providing the mold of claim 1;
providing a curable material between a substrate and said shape-imparting layer of said mold;
curing said material forming a fine structure integrally bonded with said substrate; and
releasing said fine structure from said mold.

20. The method of claim 19, wherein said curing comprises photo-curing.

21. The method of claim 19, wherein said fine structure are ribs on a back plate of a plasma display panel.
